(19) United States
(12) Patent Application Publication
(10) Pub. No.: US 2010/0259206 A1
(43) Pub. Date: Oct. 14, 2010

(54) METHOD FOR DRIVING AN ELECTRICAL CONVERTER AND ASSOCIATED APPARATUS

(76) Inventor: Dirk Joachimsmeyer, Hausen (DE)

Correspondence Address: King & Spalding LLP, 401 Congress Avenue, Suite 3200, Austin, TX, 78701, US

(21) Appl. No.: 12/675,796

(22) PCT Filed: Aug. 22, 2008
(86) PCT No.: PCT/EP08/60998

§ 371 Date: Jun. 29, 2010

(30) Foreign Application Priority Data
Aug. 28, 2007 (DE) 10 2007 040 560.1

(51) Int. Cl. H02P 6/00

(52) U.S. Cl. 318/400.17

(57) ABSTRACT

According to a method for driving a converter (4) in accordance with a period commutation pattern, a transition region (25) is provided between a sinusoidal commutation region (21) and a block commutation region (22) in the context of the commutation pattern, in which transition region (25) a phase voltage (<U_{L1}>) output by the converter (4) is set in temporally constant fashion for a first subsection (t1) of each half-cycle (P1, P2) in the manner of block commutation, while the phase voltage (<U_{L1}>) is set in temporally varying fashion for a second subsection (t2, t3) of the half-cycle (P1, P2) in the manner of sinusoidal commutation. An apparatus (5) which is suitable for carrying out the method has a control unit (6) which is designed to generate a switching signal (PWM) for the converter (4) in accordance with the above-described method.

### CROSS-REFERENCE TO RELATED APPLICATIONS

This application is a U.S. National Stage Application of International Application No. PCT/EP2008/060998 filed Aug. 22, 2008, which designates the United States of America, and claims priority to German Application No. 10 2007 040 560.1 filed Aug. 28, 2007, the contents of which are hereby incorporated by reference in their entirety.

### TECHNICAL FIELD

The invention relates to a method for driving an electric inverter as used in particular for supplying an electric drive current to the motor phases of an electric motor. The invention further relates to an apparatus that is embodied for performing the method.

### BACKGROUND

Commutation is generally understood to mean energizing the motor phases of an electric motor by means of a drive current. Modern brushless (as they are called) electric motors are usually commutated electronically by means of an inverter circuit (referred to in the following as an inverter for short). An inverter of said kind has a number of half-bridges connected into an intermediate electric circuit, said number corresponding to the number of motor phases. Each half-bridge has two series-connected electronic power switches, e.g. in the form of MosFets or IGBTs, between which the respective associated motor phase is connected. The power switches are driven—usually under software control—by means of an electronic switching signal which consequently determines the type and manner of the commutation. A distinction is made in this regard between various commonly used commutation patterns, in particular what is termed sinusoidal commutation and what is termed block commutation. In sinusoidal commutation the power switches of the inverter are driven in such a way that the electric phase voltage injected into a motor phase by the inverter during one revolution of the motor follows an at least essentially sinusoidal time waveform. In block commutation, on the other hand, the power switches of the inverter are driven in such a way that an essentially rectangularly varying phase voltage is output by the inverter. In the case of a block commutation, therefore, the phase voltage switches essentially abruptly between discrete voltage values.

With pure sinusoidal commutation the maximum drive power that is to be transmitted to the motor is reached when the amplitude of the phase voltage goes toward the absolute value of the intermediate circuit voltage. In order nonetheless to be able to increase the power further in this case, i.e. in order to drive the motor with more than 100% pure sinusoidal power, modern inverters can sometimes be switched over from the sinusoidal commutation to a block commutation. When switching between sinusoidal commutation and block commutation, however, there is usually a jump in the drive torque generated by the motor, said jump in torque being associated with an abrupt change in the phase current. The jump in torque usually leads to a jerky change in a movement process driven by the motor which—depending on the field of application of the motor—can have a disruptive or even destructive effect. Due to the corresponding leap in the phase current transient overcurrent peaks occur within the inverter, which peaks can lead under unfavorable conditions to the shutdown of the inverter.

### SUMMARY

Accoridng to various embodiments, a method for driving an inverter is disclosed which is improved against this background. Accoridng to other embodiments, an apparatus is disclosed that is suitable for performing the method.

Accoridng to an embodiment, in a method for driving an inverter in accordance with a periodic commutation pattern, within the scope of the commutation pattern there is provided between a sinusoidal commutation region and a block commutation region a transition region in which a phase voltage output by the inverter is set to be constant with respect to time for a first sub-period of each half-cycle in the manner of block commutation, while the phase voltage for a second sub-period of the half-cycle is set to varying with respect to time in the manner of sinusoidal commutation.

According to a further embodiment, the duration of the first sub-period can be set relative to the duration of the half-cycle as a function of a manipulated variable that is characteristic of a motor power. According to a further embodiment, the duration of the first sub-period can be successively increased in the course of the transition region between the sinusoidal commutation region and the temporally following block commutation region in accordance with a predefined dependence on the time or on a commutation angle. According to a further embodiment, the duration of the first sub-period can be successively reduced in the course of the transition region between the block commutation region and the temporally following sinusoidal commutation region in accordance with a predefined dependence on the time or on a commutation angle. According to a further embodiment, the first sub-period within each half-cycle can be provided centered with respect to the second sub-period. According to a further embodiment, the driving of the inverter can be performed through specification of at least one PWM signal. According to a further embodiment, the lengthening or shortening of the first sub-period can be performed by variation of a predefined pulse-locking/pulse-dropping time. According to a further embodiment, the block commutation region can be set by setting a predefined pulse-locking/pulse-dropping time to the cycle duration of a PWM cycle of the PWM signal. According to a further embodiment, the duration of the first sub-period can be varied in a quantized manner in accordance with a predefined gradation.

Accoridng to another embodiment, an apparatus for driving an inverter has a control unit for specifying at least one switching signal for the inverter, wherein the control unit is embodied to generate the switching signal in accordance with a periodic commutation pattern in such a way that within the scope of the commutation pattern there is disposed between a sinusoidal commutation region and a block commutation region a transition region in which an averaged phase voltage output by the inverter is set to be constant for a first sub-period of each half-cycle in the manner of block commutation, and to varying for a second sub-period of the half-cycle in the manner of sinusoidal commutation.

According to a further embodiment, the control unit can be embodied for setting the duration of the first sub-period relative to the duration of the half-cycle as a function of a manipulated variable that is characteristic of a motor power. According to a further embodiment, the control unit can be embodied for successively increasing the duration of the first sub-period in the course of the transition region between the sinusoidal commutation region and the temporally following block commutation region in accordance with a predefined dependence on the time or on a commutation angle. According to a further embodiment, the control unit can be embodied for successively reducing the duration of the first sub-period in the course of the transition region between the block commutation region and the temporally following sinusoidal commutation region in accordance with a predefined dependence on the time or on a commutation angle. According to a further embodiment, the control unit can be embodied for setting the first sub-period within each half-cycle to centered with respect to the second sub-period. According to a further embodiment, the control unit can be embodied for performing the driving of the inverter through specification of at least one PWM signal. According to a further embodiment, the control unit can be embodied for performing the lengthening or shortening of the first sub-period by variation of a predefined pulse-locking/pulse-dropping time. According to a further embodiment, the control unit can be embodied for setting the block commutation region by setting a predefined pulse-locking/pulse-dropping time to the cycle duration of a PWM cycle of the PWM signal. According to a further embodiment, the control unit can be embodied for varying the duration of the first sub-period in a quantized manner according to a predefined gradation.

### BRIEF DESCRIPTION OF THE DRAWINGS

Exemplary embodiments are described in more detail below with reference to a drawing, in which:

FIG. 1 shows in a roughly schematically simplified circuit diagram an electric motor having an inverter connected upstream thereof and an apparatus for driving the inverter,

FIG. 2 shows in a schematic diagram serving by way of example for a phase of the electric motor the phase voltage averaged over a PWM cycle duration in the case of sinusoidal commutation, plotted against time or, as the case may be, against the so-called commutation angle,

FIG. 3 shows in a detailed representation a time section III of the diagram according to FIG. 2,

FIG. 4 shows in a representation according to FIG. 2 the waveform of the phase voltage in the case of block commutation,

FIG. 5 shows with reference to five vertically arranged diagrams according to FIG. 2 a transition between sinusoidal commutation and block commutation, wherein the shape of the phase voltage curve in a transition region is determined as a function of a variable that is characteristic of the desired power of the electric motor, and

FIG. 6 shows in a representation according to FIG. 2 an alternative transition between sinusoidal commutation and block commutation, wherein the shape of the phase voltage curve in a corresponding transition region is varied as a function of time or of the commutation angle.

Parts and magnitudes corresponding to one another are always labeled with the same reference signs in all the figures.

### DETAILED DESCRIPTION

According to various embodiments it is provided that within the scope of a periodic commutation pattern a transition region is provided between a sinusoidal commutation region and a block commutation region, in which transition region a phase voltage output by the inverter is set to constant for a first sub-period of each half-cycle of the commutation pattern in the manner of block commutation and set to varying for a second part of the half-cycle in the manner of sinusoidal commutation.

What is generally understood by the term “commutation pattern” is a specific type of control of the inverter, that is to say a specific shaping of a switching signal which is issued to the inverter and on the basis of which a phase voltage output by the inverter takes a specific time waveform. The commutation pattern is periodic, i.e. comprises a plurality of sequential time segments (cycle periods) in which the commutation pattern repeats itself in an identical or similar way. In this case the cycle period of the commutation pattern corresponds to one revolution of the rotary field generated in the motor by the inverter. The terms “sinusoidal commutation region”, “block commutation region” and “transition region” refer to time segments of the commutation pattern in which the commutation pattern exhibits uniform characteristic properties. Thus, in the sinusoidal commutation region the phase voltage becomes sinusoidal with respect to time, while in the block commutation region it varies according to a rectangular pulse scheme. In sinusoidal commutation the cycle period conventionally starts with the beginning of the positive half-wave of the sinusoidal phase voltage, i.e. at the point at which the phase voltage exceeds the mean amplitude value in the positive direction. In block commutation the cycle period conventionally starts likewise with the commencement of the positive half-wave, i.e. with the commencement of the positive drive phase of the commutation pattern. Accordingly the start of the cycle period for the transition region is also fixed to the beginning of the positive half-wave of the transition commutation pattern. The positive or negative half-waves of the respective commutation pattern are referred to analogously as a half-cycle.

By means of the method an essentially continuous transition is created between sinusoidal commutation and block commutation, as a result of which abrupt changes in the drive torque generated by the motor and in the underlying phase current are avoided. Accordingly the negative effects of such abrupt changes on the movement process driven by the motor or, as the case may be, on the inverter are avoided.

In a first variant of the method the duration of the first sub-period is varied in accordance with a manipulated variable that is characteristic of the motor power to be set for the motor driven by the inverter. Said manipulated variable is normalized in particular to 100% pure sinusoidal power.

In an alternative variant of the method, switching between sinusoidal commutation and block commutation is accomplished discretely in accordance with the motor power. The transition between these two forms of commutation takes place on a time basis though not abruptly, but is effected in each case via the intermediate transition region which in this embodiment of the method is always used in a temporally transient manner. The duration of the first sub-period (in relation to the duration of the half-cycle) is in this case varied in accordance with a predefined time dependence or as a function of what is referred to as the commutation angle.

Thus, in the case of a transition from the sinusoidal commutation region to a following block commutation region the duration of the first sub-period is successively lengthened in relation to the second sub-period. In addition or alternatively, in the case of a transition from a block commutation region to a following sinusoidal commutation region the duration of the first sub-period is successively shortened.

In a preferred embodiment of the method the first sub-period is set centered in time with respect to the second sub-period. The result of this is that in the transition region the time segments having block-like constant phase voltages are always arranged at the points of the commutation pattern at which the minima and maxima of the phase voltage would lie in the case of pure sinusoidal commutation. What is achieved by this is that the transition commutation pattern, in particular at the edge of the transition region bordering on the sinusoidal commutation region, is aligned as far as possible to the commutation pattern corresponding to a pure sinusoidal commutation. In this way the switch from pure sinusoidal commutation into the transition region takes place particularly continuously.

The switching signal applied to the inverter for controlling same is preferably pulse-width-modulated, in other words includes a series of pulses timed in accordance with a fixed cycle duration and pulse gaps disposed therebetween, with the signal being modulated by variable setting of the (temporal) pulse width of the pulses. In this embodiment of the method the switching signal is referred to as a PWM signal. If the inverter is driven on the basis of pulse width modulation, the aforementioned phase voltage is given by the mean value of the instantaneous phase voltage formed over the duration of the PWM signal cycle. This effective phase voltage is always proportional to the pulse width.

In an embodiment of the method that is particularly easy to implement the lengthening or, as the case may be, shortening of the first sub-period is accomplished through variation of a predefined pulse-locking/pulse-dropping (PLPD) time. By this means a pulse-locking/pulse-dropping (PLPD) function mostly provided per se also within the scope of a conventional driving method can be used—contrary to the actual intended use of such a function—for forming the commutation pattern in the transition region. In this way the method according to the invention can implemented with only minor modification of known control algorithms—consequently without major development overhead.

In addition or alternatively the PLPD function is advantageously used also for generating the switching signal in the block commutation region, in other words for implementing a pure form of block commutation. In order to generate the block commutation the predefined PLPD is in this case simply set to the cycle duration of the PWM signal.

In a particularly resource-saving, i.e. particularly undemanding in terms of computational overhead, embodiment of the method the duration of the first sub-period is varied not continuously, but in a quantized manner according to a predefined gradation. This removes in particular the need to recalculate the duration of the first sub-period every time during iterative performance of the method.

According to other embodiments, an apparatus comprises a control unit embodied in terms of circuitry and/or programming for the purpose of generating the switching signal in accordance with the method described hereintofore. The control unit is in particular a microcontroller in which control logic performing the method is implemented in the form of software.

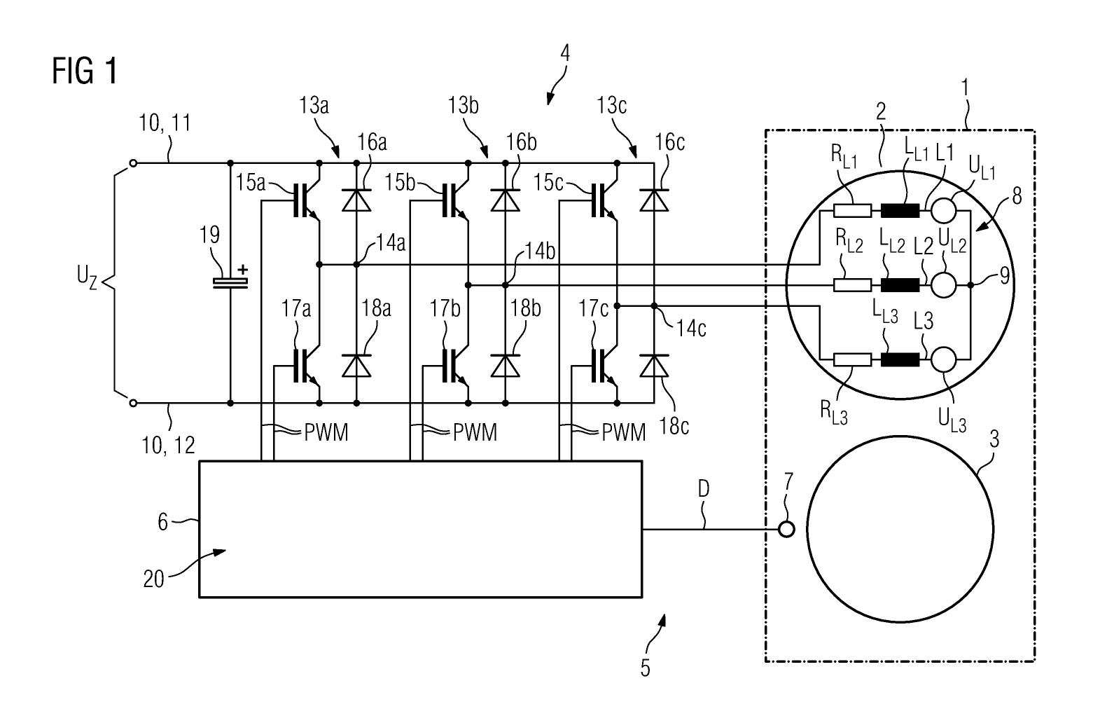

FIG. 1 shows in roughly schematic form an (electric) motor 1 having a stator 2 and a rotor 3 rotatably mounted therein. The motor is, for example, a permanently excited synchronous motor. In this arrangement the rotor 3 is provided with permanent magnets for generating a rotor magnetic field. In addition, however, other motor types, in particular also asynchronous motors or electrically excited synchronous motors, can basically also be used within the scope of the invention. The motor 1 is provided in particular for use in a hybrid drive of a motor vehicle.

FIG. 1 also shows an inverter 4 as well as an apparatus 5 for driving the inverter 4. Said apparatus 5 comprises a control unit 6 in the form of a microcontroller as well as a rotor position sensor 7 which detects the rotational position of the rotor 3 relative to the stator 2 during the operation of the motor 1.

The stator 2 of the motor 1 is wound with a rotary field winding 8 for generating a magnetic stator rotary field. The rotary field winding 8 comprises three winding phases, referred to hereinbelow as motor phases L1, L2 and L3, which are connected together in a neutral point 9. In terms of its physical properties each motor phase L1, L2, L3 is characterized by an inductor L_{L1}, LL2, LL3, an ohmic resistor R_{L1}, RL2, RL3 and an induced voltage U_{L1}, UL2, UL3. The inductors L_{L1}, LL2, LL3, resistors R_{L1}, RL2, RL3 and voltages U_{L1}, UL2, UL3 are entered in FIG. 1 in the form of an equivalent circuit diagram.

The inverter 4 comprises an intermediate electric circuit 10 having a high-potential side 11 and a low-potential side 12, between which an intermediate circuit voltage U_{Z} is applied during operation of the motor 1.

In the intermediate circuit 10, three half-bridges 13a, 13b, 13c are connected in parallel for the purpose of feeding one motor phase L1, L2, L3 in each case. Each half-bridge 13a, 13b, 13c comprises a phase terminal 14a, 14b, 14c to which the associated motor phase L1, L2, L3 is connected.

Between the respective phase terminal 14a, 14b, 14c and the high-potential side 11 of the intermediate circuit 10, each half-bridge 13a, 13b, 13c includes a high-potential-side power switch 15a, 15b, 15c in the form of an IGBT. A freewheeling diode 16a, 16b, 16c is connected in parallel with each of these power switches 15a, 15b, 15c in each case. Within the scope of each half-bridge 13a, 13b, 13c a low-potential-side power switch 17a, 17b, 17c is connected in each case between the motor terminal 14a, 14b, 14c and the low-potential side 12 of the intermediate circuit 10. Each of these power switches 17a, 17b, 17c is in turn embodied in the form of an IGBT and is flanked by a freewheeling diode 18a, 18b, 18c connected in parallel.

The inverter 4 also includes a capacitor 19 connected into the intermediate circuit 10 in a parallel circuit to the half-bridges 13a, 13b, 13c for the purpose of compensating for voltage ripple during operation of the motor 1.

The control unit 6 is connected on the input side to the rotor position sensor 7 and during operation of the motor 1 receives from said sensor a rotor position signal D containing information about the current rotational position of the rotor 3 in relation to the stator 2. The rotor position sensor 7 is an absolute position sensor which uses, for example, what is known as the Hall effect or an inductive coupling to the rotor magnetic field generated by the rotor 3 for the purpose of generating the rotor position signal D.

On the output side the control unit 6 is connected in each case to the control terminal or, as the case may be, gate terminal of each of the power switches 15a, 15b, 15c and 17a, 17b, 17c. By outputting a digital switching signal the control unit 6 switches the power switches 15a, 15b, 15c and 17a, 17b, 17c during operation of the motor 1 reversibly between an electrically conducting and an electrically blocking state in order to vary the phase voltages applied in the motor phases L1, L2, L3 in accordance with a predefined commutation pattern. Said switching signals are pulse-width-modulated and are therefore referred to in the following as PWM signal PWM.

A setpoint value for the rotational speed of the motor is also supplied to the control unit (in a manner not explained in further detail) as a control variable.

Implemented in the control unit in the form of one or more software modules is control logic 20 which performs a method—described in more detail below—for driving the inverter 4, i.e. for generating the PWM signals PWM, during operation of the motor 1.

In this case the control logic 20 calculates an actual value for the motor's rotational speed from the time curve of the rotor position signal D. The control logic 20 also determines in the course of a regulation of the rotational speed a differential manipulated variable which indicates whether under the current operating conditions the motor power—or, as the case may be, the motor's rotational speed—is to be increased, reduced or kept constant.

On the basis of the rotor position signal D and the differential manipulated variable the control logic 20 then calculates a pulse width λ (FIG. 3) and in accordance with said pulse width λ and a predefined cycle duration T (FIG. 3) generates the PWM signal PWM for each of the power switches 15a, 15b, 15c and 17a, 17b, 17c.

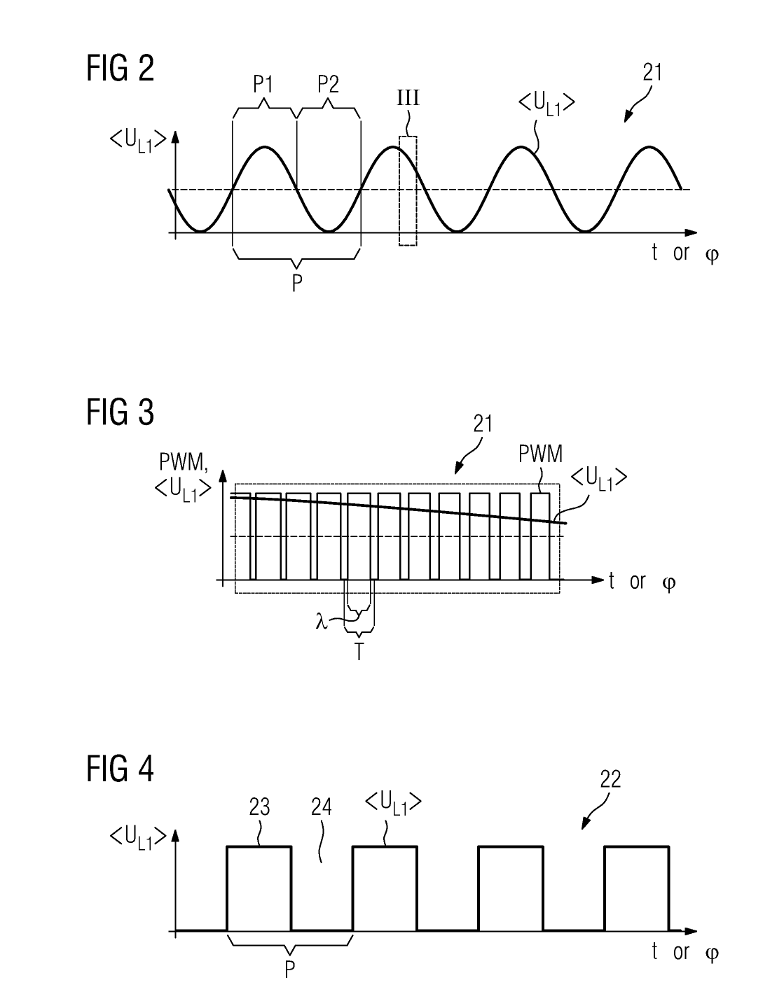

During normal operation of the motor 1, which is to say at low or medium motor power, the control logic 20 performs a so-called sinusoidal commutation 21 (FIG. 2), wherein the pulse width λ of the PWM signal PWM assigned to each of the power switches 15a, 15b, 15c and 17a, 17b, 17c varies sinusoidally with the time t. Correspondingly, the phase voltage of each motor phase L1, L2, L3 averaged over the cycle duration T of the PWM clock pulse also follows a sinusoidal curve with time. The sinusoidal commutation 21 is illustrated in FIGS. 2 and 3 using the example of the effective phase voltage <U_{L1}>, i.e. the voltage averaged over the cycle duration T, of the motor phase L1 (in this case the forming of the average value is indicated formulistically by means of angle brackets < >).

The effective phase voltage <U_{L1}> oscillates synchronously with the so-called commutation angle φ, which reflects the rotary position of the magnetic stator rotary field generated by the motor phases L1, L2, L3. A cycle period P or full oscillation of the effective phase voltage <U_{L1}> therefore corresponds to a complete rotation of the magnetic rotary field, and hence to a change in the commutation angle φ by 360°.

In terms of their time curve or, as the case may be, commutation-angle-dependent characteristic, the averaged phase voltages of the remaining motor phases L2 and L3 are equal to the phase voltage <U_{L1}>, but are phase-shifted with respect to the latter by a commutation angle value of 120° and 240° respectively.

In order to be able to operate the motor 1 in a high power range at more than 100% pure sinusoidal power, the control logic 20 can switch over from the sinusoidal commutation 21 shown in FIG. 2 to a so-called block commutation 22, as shown in FIG. 4—again by way of example for the phase voltage <U_{L1}>. In this case the phase voltage <U_{L1}> is set by corresponding driving of the power switches 15a, 15b, 15c and 17a, 17b, 17c in such a way that within a cycle period P it exhibits a square wave pulse 23 and a following pulse gap 24. The pulse width λ of the high-potential-side power switch 15a-15c assigned in each case is set to λ=100% T for the duration of the square wave pulse 23, and to λ=0 for the duration of the pulse gap 24. The assigned power switch 17a-17c is always driven in the opposite direction hereto. The phase voltages of the remaining phases L2 and L3 are in turn equal in terms of their time characteristic curve to the phase voltage <U_{L1}>, but are phase-shifted with respect to the latter by a commutation angle difference of 120° and 240° respectively.

In the method performed by means of the control logic 20 the transition between pure sinusoidal commutation 21 and pure block commutation 22 does not take place abruptly. Rather, there is provided between said two extreme commutation patterns a transition region 25 in which the commutation pattern—and resulting therefrom the shape of the phase voltage <U_{L1}>—is successively transitioned from the sinusoidal mode into the block mode (or vice versa). This transition is achieved in that, starting from the pure sinusoidal mode, the commutation is modified in such a way that in each half-cycle P1, P2 of the cycle period P a first sub-period t1 is provided in which the phase voltage <U_{L1}> is held constant at a maximum value essentially corresponding to the intermediate circuit voltage U_{Z}. In this case the sub-period t1 is centered in time with respect to the half-cycle P1 such that the section of constant phase voltage <U_{L1}> always coincides with those sections of the voltage curve in which the maxima or, as the case may be, minima of the phase voltage <U_{L1}> would occur in the case of pure sinusoidal commutation 21. In equal-sized time segments t2 and t3 before and after the sub-period t1 respectively the phase voltage <U_{L1}> is commutated sinusoidally.

The successive transition between pure sinusoidal mode and pure block mode is performed according to the method in that to the detriment of the remaining sub-period t2+t3 of the respective half-cycle P1, P2 the duration of the sub-period t1 is increased all the more, the more the commutation pattern in the transition region 25 is to be aligned to the pure block mode. The sub-period t1 is therefore comparatively small at the edge of the transition region adjacent to the sinusoidal mode in relation to the remaining sub-period t2+t3, and, in contrast, comparatively large at the edge of the transition region adjacent to the pure block mode.

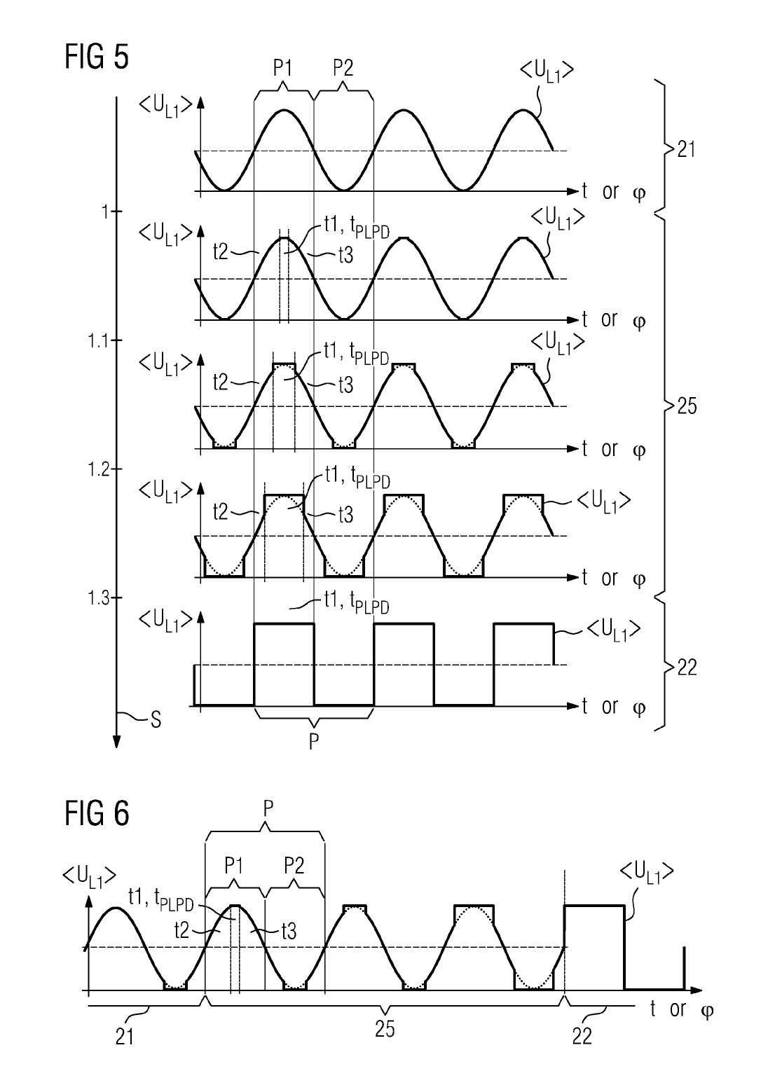

In a first variant of the method performed by the control logic 20 as shown in FIG. 5 the length of the sub-period t1 in the transition region is set as a function of a manipulated variable S that is characteristic of the motor power. In the example shown in FIG. 5 said manipulated variable S is normalized to 100% pure sinusoidal power. It therefore specifies the motor power set by the control logic 20 in relation to 100% sinusoidal power, and when the maximum sinusoidal power is reached it has the value 1.

The control logic 20 operates analogously for S≦1 in pure sinusoidal mode. In this region the manipulated variable S essentially corresponds to the amplitude of the phase voltage <U_{L1}> normalized to the intermediate circuit voltage U_{Z}. For values of S≧1 the sub-period t1 is incrementally increased until at such time as an upper power threshold value is exceeded—S=1.3 in the example according to FIG. 5—the time period t1 is aligned to the entire duration of the half-cycle P1 or P2, and consequently the pure block mode is reached.

TAB 1 shows the functional dependence of the sub-period t1 of the manipulated variable S for the example shown in FIG. 5.

TABLE 1

| S | t1/(t1 + t2 + t3) | Commutation pattern |
|---|---|---|
| ≦1 | 0 | Sinusoidal mode |
| 1 < S ≦ 1.1 | 0.2 | Transition region |
| 1.1 < S ≦ 1.2 | 0.4 | |
| 1.2 < S ≦ 1.3 | 0.75 | |
| >1.3 | 1 | Block mode |

In order to implement the voltage curve in the transition region with particularly low numeric overhead the control logic 20 resorts to an integrated pulse-locking/pulse-dropping (PLPD) function.

By means of said function a pulse of the PWM signal PWM is suppressed if its pulse width λ falls below a predefined PLPD time t_{PLPD} (pulse dropping). Furthermore, a pulse of the PWM signal PWM is extended over the entire cycle duration T when the difference of the pulse width λ from the cycle duration T falls below the predefined PLPD time t_{PLPD} (pulse locking). In other words the pulse gap formed between two pulses of the PWM signal PWM is suppressed by means of pulse locking when the duration of said pulse gap is less than the PLPD time t_{PLPD}.

During normal operation of the apparatus 5 the PLPD function serves to avoid excessively short switching pulses which cannot be performed in the correct manner by the inverter 4 due to the design-related switching times of the power switches 15a, 15b, 15c and 17a, 17b, 17c. During normal operation the PLPD time t_{PLPD} is set to a very small constant value of approx. 6 μsec in order to avoid non-harmonic signal distortions.

In contrast hereto the PLPD time t_{PLPD} in the transition region 25 is varied as a function of the manipulated variable S in that the PLPD time t_{PLPD} is always set to the value desired for the sub-period t1. As a result of the properties of the PLPD function the curve progression of the phase voltage <U_{L1}> shown in FIG. 5 then establishes itself automatically. In particular the pure block commutation 22 is also realized by means of the PLPD function in that the PLPD time t_{PLPD} is set to a value corresponding to the duration of the respective half-cycle P1, P2.

FIG. 6 shows a variant of the method performed by the control logic 20. In contrast to the method variant described above, in this instance the sub-period t1 is varied in the transition region 25, not as a function of the motor power, but on the basis of a predefined time dependence or as a function of the commutation angle φ. For example—as shown in FIG. 6—starting from the beginning of the transition region 25, the sub-period t1 is increased incrementally in size with each following cycle period P on the basis of a predefined quantization rule until the block mode 22 is reached. Optionally, such a transition region in which the duration of the sub-period t1 is incrementally reduced in size with each cycle period P is also provided for the transition from the block mode into the sinusoidal mode. The selectable values of the first sub-period are in this case specified by means of a predefined gradation (or, as the case may be, quantization rule) which corresponds in particular to the middle column of TAB 1.

For the rest, the commutation method is identical to the method variant described in connection with FIG. 5. In particular the curve shape of the phase voltage <U_{L1}> in the transition region and block mode is set through variation of the PLPD time t_{PLPD}.

The variation of the commutation pattern in the transition region 25 for the phase L1 and the associated phase voltage <U_{L1}> as shown in FIGS. 5 and 6 is applied in the same way to the phase voltages of the other phases L2 or L3, which in turn are simply phase-shifted with respect to the phase voltage <U_{L1}>.

What is claimed is:

1. A method for driving an inverter in accordance with a periodic commutation pattern, comprising the step:
Providing within the scope of the periodic commutation pattern between a sinusoidal commutation region and a block commutation region a transition region in which a phase voltage output by the inverter is set to be constant with respect to time for a first sub-period of each half-cycle in the manner of block commutation, while the phase voltage for a second sub-period of the half-cycle is set to vary with respect to time in the manner of sinusoidal commutation.

2. The method according to claim 1, wherein the duration of the first sub-period is set relative to the duration of the half-cycle as a function of a manipulated variable that is characteristic of a motor power.

3. The method according to claim 1, wherein the duration of the first sub-period is successively increased in the course of the transition region between the sinusoidal commutation region and the temporally following block commutation region in accordance with a predefined dependence on the time or on a commutation angle.

4. The method according to claim 1, wherein the duration of the first sub-period is successively reduced in the course of the transition region between the block commutation region and the temporally following sinusoidal commutation region in accordance with a predefined dependence on the time or on a commutation angle.

5. The method according to claim 1, wherein the first sub-period within each half-cycle is provided centered with respect to the second sub-period.

6. The method according to claim 1, wherein the driving of the inverter is performed through specification of at least one PWM signal.

7. The method according to claim 6, wherein the lengthening or shortening of the first sub-period is performed by variation of a predefined pulse-locking/pulse-dropping time.

8. The method according to claim 6, wherein the block commutation region is set by setting a predefined pulse-locking/pulse-dropping time to the cycle duration of a PWM cycle of the PWM signal.

9. The method according to claim 1, wherein the duration of the first sub-period is varied in a quantized manner in accordance with a predefined gradation.

10. An apparatus for driving an inverter, comprising a control unit for specifying at least one switching signal for the inverter, wherein the control unit is operable to generate the switching signal in accordance with a periodic commutation pattern in such a way that within the scope of the commutation pattern there is disposed between a sinusoidal commutation region and a block commutation region a transition region in which an averaged phase voltage output by the inverter is set to be constant for a first sub-period of each half-cycle in the manner of block commutation, and to varying for a second sub-period of the half-cycle in the manner of sinusoidal commutation.

11. The apparatus according to claim 10, wherein the control unit is operable to set the duration of the first sub-period relative to the duration of the half-cycle as a function of a manipulated variable that is characteristic of a motor power.

12. The apparatus according to claim 10, wherein the control unit is operable to successively increase the duration of the first sub-period in the course of the transition region between the sinusoidal commutation region and the temporally following block commutation region in accordance with a predefined dependence on the time or on a commutation angle.

13. The apparatus according to claim 10, wherein the control unit is operable to successively reduce the duration of the first sub-period in the course of the transition region between the block commutation region and the temporally following sinusoidal commutation region in accordance with a predefined dependence on the time or on a commutation angle.

14. The apparatus according to claim 10, wherein the control unit is operable to set the first sub-period within each half-cycle to centered with respect to the second sub-period.

15. The apparatus according to claim 10, wherein the control unit is embodied for performing the driving of the inverter through specification of at least one PWM signal.

16. The apparatus according to claim 15, wherein the control unit is operable to perform the lengthening or shortening of the first sub-period by variation of a predefined pulse-locking/pulse-dropping time.

17. The apparatus according to claim 15, wherein the control unit is operable to set the block commutation region by setting a predefined pulse-locking/pulse-dropping time to the cycle duration of a PWM cycle of the PWM signal.

18. The apparatus according to claim 10, wherein the control unit is operable to vary the duration of the first sub-period in a quantized manner according to a predefined gradation.

19. An apparatus for driving an inverter, comprising
a control unit generating at least one switching signal for the inverter in accordance with a periodic commutation pattern in such a way that within the scope of the commutation pattern there is disposed between a sinusoidal commutation region and a block commutation region a transition region in which an averaged phase voltage output by the inverter is set to be constant for a first sub-period of each half-cycle in the manner of block commutation, and to vary for a second sub-period of the half-cycle in the manner of sinusoidal commutation.

20. The apparatus according to claim 19, wherein the control unit is operable to set the duration of the first sub-period relative to the duration of the half-cycle as a function of a manipulated variable that is characteristic of a motor power.
